(19) United States
(12) Patent Application Publication
(10) Pub. No.: US 2026/0190149 A1
(43) Pub. Date: Jul. 2, 2026

(54) ENHANCED TRANSMISSION DURING A RANDOM ACCESS (RA) PROCEDURE

(71) Applicant: Nokia Technologies Oy, Espoo (FI)

(72) Inventors: Alessio MARCONE, Munich (DE); Bo BI, Hangzhou (CN); Frank FREDERIKSEN, Aalborg (DK); Arman AHMADZADEH, Munich (DE)

(21) Appl. No.: 18/842,943

(22) PCT Filed: Aug. 31, 2023
(86) PCT No.: PCT/CN2023/116154

§ 371 Date: Aug. 30, 2024

(51) Int. Cl. H04W 74/0833; H04W 72/232

(52) U.S. Cl. CPC H04W 74/0833; H04W 72/232

(57) ABSTRACT

Example embodiments of the present disclosure relate to a solution for an enhanced transmission during a random access (RA) procedure. In the solution, a first device, receives, from a second device, first information associated with an enhanced transmission of a message with a first transmission direction which is transmitted from the second device to the first device during a random access (RA) procedure; and receives, based on the first information, the enhanced transmission of the message with the first transmission direction from the second device during the RA procedure.

### FIELDS

Various example embodiments of the present disclosure generally relate to the field of telecommunication and in particular, to methods, devices, apparatuses and computer readable storage medium for an enhanced transmission during a random access (RA) procedure.

### BACKGROUND

Wireless communication networks are widely deployed and may support various types of service applications for terminal devices. Generally speaking, a terminal device (also referred to as user equipment, UE) needs to perform a random access (RA) procedure with the network such that the terminal device may communicate data transmission with the network. In view of this, it is important to ensure that terminal deice may perform the RA successfully.

### SUMMARY

In a first aspect of the present disclosure, there is provided a first device. The first device includes at least one processor; and at least one memory storing instructions that, when executed by the at least one processor, cause the first device at least to: receive, from a second device, first information associated with an enhanced transmission of a message with a first transmission direction which is transmitted from the second device to the first device during a random access (RA) procedure; and receive, based on the first information, the enhanced transmission of the message with the first transmission direction from the second device during the RA procedure.

In a second aspect of the present disclosure, there is provided a second device. The second device includes at least one processor; and at least one memory storing instructions that, when executed by the at least one processor, cause the second device at least to: transmit, to a first device, first information associated with an enhanced transmission of a message with a first transmission direction transmitted from the second device to the first device during a random access (RA) procedure; and transmit, based on the first information, the enhanced transmission of the message with the first transmission direction to the first device during the RA procedure.

In a third aspect of the present disclosure, there is provided a method. The method includes: receiving, at a first device and from a second device, first information associated with an enhanced transmission of a message with a first transmission direction which is transmitted from the second device to the first device during a random access (RA) procedure; and receiving, based on the first information, the enhanced transmission of the message with the first transmission direction from the second device during the RA procedure.

In a fourth aspect of the present disclosure, there is provided a method. The method includes: transmitting, at a second device and to a first device, first information associated with an enhanced transmission of a message with a first transmission direction transmitted from the second device to the first device during a random access (RA) procedure; and transmitting, based on the first information, the enhanced transmission of the message with the first transmission direction to the first device during the RA procedure.

In a fifth aspect of the present disclosure, there is provided a first apparatus. The first apparatus includes means for receiving, from a second apparatus, first information associated with an enhanced transmission of a message with a first transmission direction which is transmitted from the second apparatus to the first apparatus during a random access (RA) procedure; and means for receiving, based on the first information, the enhanced transmission of the message with the first transmission direction from the second apparatus during the RA procedure.

In a sixth aspect of the present disclosure, there is provided a second apparatus. The second apparatus includes means for transmitting, to a first apparatus, first information associated with an enhanced transmission of a message with a first transmission direction transmitted from the second apparatus to the first apparatus during a random access (RA) procedure; and means for transmitting, based on the first information, the enhanced transmission of the message with the first transmission direction to the first apparatus during the RA procedure.

In a seventh aspect of the present disclosure, there is provided a computer readable medium. The computer readable medium includes instructions stored thereon for causing an apparatus to perform at least the method according to the third aspect.

In an eighth aspect of the present disclosure, there is provided a computer readable medium. The computer readable medium includes instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure may become easily comprehensible through the following description.

### BRIEF DESCRIPTION OF THE DRAWINGS

Some example embodiments may now be described with reference to the accompanying drawings, where:

FIG. 1A illustrates an example communication environment in which example embodiments of the present disclosure may be implemented;

FIG. 1B illustrates a signaling flow of communication of 4-step RA;

FIG. 1C illustrates a signaling flow of communication of 2-step RA;

FIG. 2 illustrates a signaling flow of communication in accordance with some embodiments of the present disclosure;

FIG. 3 illustrates another signaling flow of communication in accordance with some embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure may now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It would be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there may be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like.

A work item (WI) of the 3rd generation partnership project (3GPP) release-18 non-terrestrial network (NTN) are focusing on the applicability of the solutions developed by general NR coverage enhancement to the NTN, and are trying to identify potential issues and enhancements, considering the NTN characteristics including large propagation delay and satellite movement.

It has been proposed to specify physical uplink control channel (PUCCH) enhancements about hybrid automatic repeat request-acknowledgement (HARQ-ACK) for message 4 (Msg 4), e.g., repetition. Further, it also has been proposed to study demodulation reference signal (DMRS) bundling for physical uplink shared channel (PUSCH) taking into account NTN-specifics (e.g., time-frequency pre-compensation).

It may be seen that the proposed enhancements are focused mostly on UL enhancements, i.e., on enhancements of the Msg 4 HARQ-ACK and enhancements to the DMRS bundling framework for PUSCH.

However, generally speaking, the coverage performance is influenced by both of the different UL and DL channels status. For example, in NTN when considering satellite power limitations (due to for example regulatory requirements or power split among the beams of the satellite), the channels related to initial access need to be enhanced. When considering PFD limits or more generically limits on satellite output power, coverage enhancements for the Msg 2 PDSCH channel are necessary. Similar limitations and needs for enhancements are found for the Msg 4/Msg B PDSCH channel.

Generally speaking, for improving coverage, there are three fundamental approaches that may be considered, including (a) lowering the interference and noise contributions, (b) increasing the transmission power, and (c) increasing the energy per bit (through either reducing the payload or by transmitting over longer time). Options (a) and (b) are not applicably due to such as PFD limits. Option (c) is typically achieved by introducing repetitions of the channel to be enhanced.

In the traditional solution, the DCI format 1_0 with cyclic redundancy check (CRC) scrambled by random access (RA)-radio network temporary identity (RNTI) is used by the network to schedule the resources for the Msg 2 PDSCH, wherein the RA-RNTI is a radio network identifier value based on the RACH Occasion (RO) in which the UE has transmitted the PRACH preamble. The following information is transmitted by means of the DCI format 1_0 with CRC scrambled by RA-RNTI or MsgB-RNTI:
Frequency domain resource assignment—

$$⌈ {log}_{2} ( {N}_{RB}^{DL , BWP} ( {N}_{RB}^{DL , BWP} + 1 ) / 2 ) ⌉ bits ;$$

$${N}_{RB}^{DL , BWP}$$

is the size of control-resource set (CORESET) 0 if CORESET 0 is configured for the cell and

$${N}_{RB}^{DL , BWP}$$

is the SIZE of initial DL bandwidth part if CORESET 0 is not configured for the cell;
Time domain resource assignment—4 bits;
VRB-to-PRB mapping—1 bit;
Modulation and coding scheme—5 bits;
transport block (TB) scaling—2 bits;
least significant bits (LSBs) of single frequency network (SFN)-2 bits for the DCI format 1_0 with CRC scrambled by MsgB-RNTI if msgB-responseWindow is configured to be larger than 10 ms; or 2 bits for the DCI format 1_0 with CRC scrambled by RA-RNTI] for operation in a cell with shared spectrum channel access if ra-ResponseWindow or ra-ResponseWindow-v1610 is configured to be larger than 10 ms; 0 bit otherwise;
Reserved bits—(16-A) bits for operation in a cell without shared spectrum access in frequency range 1 and frequency range 2-1, (18-A) for operation in a cell with shared spectrum access in frequency range 1 or for operation in a cell in frequency range 2-2, where the value of A is the number of bits for the field of ‘LSBs of SFN’ as defined above.

It may be seen that, in the traditional solution, PDSCH repetitions of Msg 2 (or Msg B) have not been supported.

In the traditional solution, the field TB scaling is of size 2 bits and indicates the scaling factor to be applied in the calculation of the transport block size (TBS) of the Msg 2. The scaling factor is determined based on the TB scaling field in the DCI format 1_0 with CRC scrambled by P-RNTI, or RA-RNTI, MsgB-RNTI as in below table 1.

TABLE 1

| TB scaling field | Scaling factor S |
|---|---|
| 00 | 1 |
| 01 | 0.5 |
| 10 | 0.25 |
| 11 | reserved |

As discussed above, for improving the physical layer performance of a channel, the approach that is typically used is to assign a larger number of resources for transmission of the channel for a certain number of bits. One approach to achieve this is to repeat the channel multiple times, to give the possibility to a receiver to combine the received signals and improve the reliability of the demodulated and decoded bits.

In view of this, one solution that could be followed in the enhancements of the coverage of the Msg 2/Msg 4/Msg B PDSCH may be to repeat the Msg 2/Msg 4/Msg B PDSCH multiple times in a same or different slot and thereby allow a UE receiver to combine the received PDSCH single transmissions.

In order to be able to combine the multiple Msg 2/Msg 4/Msg B PDSCH repetitions, it is necessary for the UE to know how many repetitions are to be transmitted by the gNB, and hence the time span of the PDSCH repetitions.

According to the present disclosure, solution used for indicating the Msg 2/Msg 4/Msg B PDSCH repetitions or, more generically, of a repetition factor of Msg 2/Msg 4/Msg B PDSCH resources is proposed. In this way, the enhancements of the coverage of the Msg 2/Msg 4/Msg B may be achieved. In addition, in order to avoid resource waste at the gNB, the gNB needs to be aware of whether the Msg 2/Msg 4/Msg B repetitions are supported by the UE(s). According to some embodiments of the present disclosure, the UE may indicate the capability-related information about whether the Msg 2/Msg 4/Msg B PDSCH repetitions are supported by the UE. In this way, unnecessary Msg 2/Msg 4/Msg B repetitions are avoided.

In the following, the message 2 (Msg 2) may be used as example of the second message for describing some example embodiments of the present disclosure. It is noted that example embodiments of the present disclosure are equally applicable to message 4 (Msg 4) and message B (Msg B). Merely for brevity, the same or similar contents are omitted herein.

As used herein, terms “requirement” and “capability” may be used interchangeably; terms “extension factor”, “repetition number” and “repetition factor” may be used interchangeably.

As used herein, terms “message enhancement”, “message repetitions” and “resource extension” may be used interchangeably.

### Example Environment

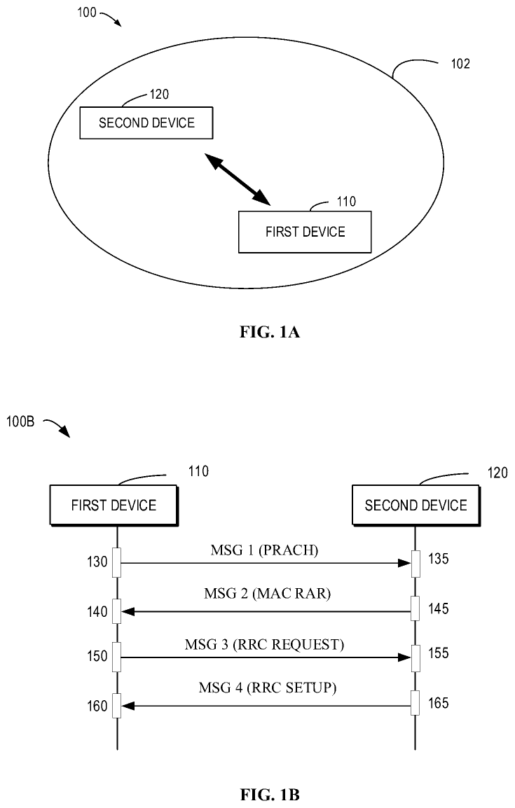

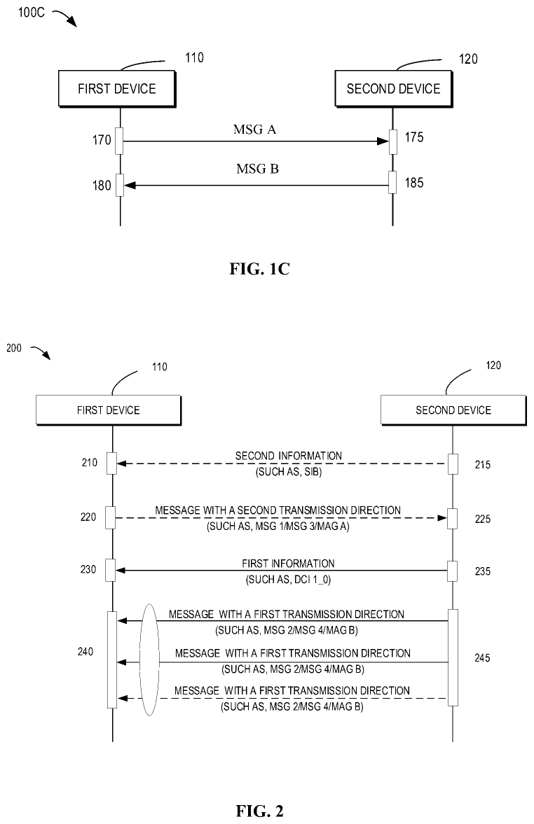

FIG. 1A illustrates an example communication environment 100A in which example embodiments of the present disclosure may be implemented. The communication environment 100A includes a first device 110 and a second device 120. A serving area provided by the second device 120 is called a cell. The second device 120 may provide one or more cells, for example, a cell 102 as illustrated in FIG. 1A.

In some example embodiments, the first device 110 may be included in a terminal device and the second device 120 may be included in a network device serving the terminal device.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is an RX device (or a receiver).

Communications in the communication environment 100A may be implemented according to any proper communication protocol(s), including, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In FIG. 1A, two contention based random access (CBRA) procedures are supported, namely 4-step RA (also referred to as 4-step RA channel, 4-step RACH) and 2-step RA (also referred to as 2-step RACH).

Reference is now made to FIG. 1B, which illustrates a signaling flow 100B of communication of 4-step RA. As illustrated in FIG. 1B, the first device 110 transmits 130 message 1 (Msg1, also known as physical random-access channel (PRACH)) to the second device 120, and the second device 120 receives 135. Msg 1 from the first device 110 accordingly. Specifically, the first device 110 send a specific preamble to the second device 120 via PRACH by using a specific resource called RACH occasion (RO) or PRACH occasion.

Next, the second device 120 transmits 145 message 2 (Msg2, also known as RA response, RAR) to the first device 110, and the first device 110 receives 140 the Msg 2 from the second device 120 accordingly. Specifically, the second device 120 replies with a random-access response (RAR) message, which includes the detected preamble identity (ID), the time-advance command, a temporary cell radio network temporary identifier (TC-RNTI), and uplink (UL) grant for the transmission of Msg 3 on PUSCH.

Then, the first device 110 transmits 150. Msg 3 (also known as RRC request) to the second device 120, and the second device 120 receives 155. Msg 3 from the first device 110 accordingly. Specifically, the first device 110 responds to Msg 3 over the scheduled PUSCH with an ID for contention resolution.

Finally, the second device 120 transmits 165 message 4 (Msg 4, also known as RRC setup) to the first device 110, and the first device 110 receives 160 the Msg 4 from the second device 120 accordingly. Specifically, the second device 120 transmits 165 the contention resolution message with the contention-resolution ID to the first device 110.

Further, upon reception of Msg 4, the first device 110 sends an acknowledgement (ACK) on a physical uplink control channel (PUCCH) if its contention-resolution ID is carried by Msg 4. This completes the 4-step RACH.

In addition, prior to Msg 1, there is also a preliminary step of sending and receiving the synchronization signal block (SSB), i.e., downlink (DL) beam sweeping, which is not formally part of the RACH procedure. As a result of this preliminary step, the first device 110 selects the index of the preferred SSB beam and decodes the associated physical broadcast channel (PBCH) for master information block (MIB), system information block (SIB) and so on. This index is also used by first device 110 to identify a suitable RO for the preamble transmission (i.e., Msg 1), according to the SSB-to-RO mapping implicitly conveyed by SIB1.

Reference is now made to FIG. 1C, which illustrates a signaling flow 100C of communication of 2-step RA. As illustrated in FIG. 1C, the first device 110 transmits 170 message A (Msg A) to the second device 120, and the second device 120 receives 175. Msg A from the first device 110 accordingly. Next, the second device 120 transmits 145 message B (Msg B) to the first device 110, and the first device 110 receives 140 the Msg B from the second device 120 accordingly.

That is, 2-step RA is similar to 4-step RA as illustrated in FIG. 1B, but Msg 1 and Msg 3 are combined in a Msg A and Msg A is sent out from the first device without waiting for feedback (i.e., traditionally Msg 2) from the second device 120. Similarly, the second device 120 combines Msg 2 and Msg 4 into Msg B.

### Work Principle and Example Signaling for Communication

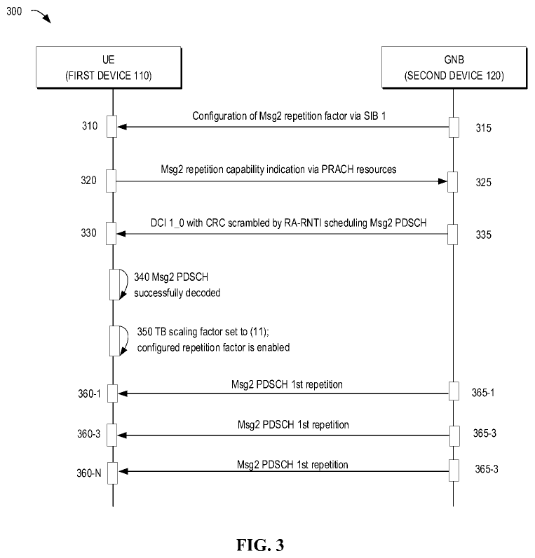

Example processes would be discussed with reference to FIG. 2 and FIG. 3. Although features are discussed separately, it should be understood features discussed below may be implemented separately or in any suitable sub-combination. In present disclosure is not limited in this regard.

It is to be understood that the operations at the first device 110 and the second device 120 should be coordinated. In other words, the second device 120 and the first device 110 should have common understanding about configurations, parameters and so on. Such common understanding may be implemented by any suitable interactions between the second device 120 and the first device 110 or both the second device 120 and the first device 110 applying the same rule/policy.

In the following, although some operations are described from a perspective of the first device 110, it is to be understood that the corresponding operations should be performed by the second device 120. Similarly, although some operations are described from a perspective of the second device 120, it is to be understood that the corresponding operations should be performed by the first device 110. Merely for brevity, some of the same or similar contents are omitted here.

Merely for a better understanding, in the following, the first device 110 may be described as a terminal device (e.g., UE) and the second device 120 may be described as a network device (e.g., NW).

Reference is made to FIG. 2, which illustrates a signaling flow 200 of communication in accordance with some embodiments of the present disclosure. For the purposes of discussion, the signaling flow 200 may be discussed with reference to FIG. 1A, for example, by using the first device 110 and the second device 120.

In operation, the first device 110 receives (230) first information from the second device 120, wherein the first information may be associated with an enhanced transmission of a message with a first transmission direction which may be transmitted from the second device 120 to the first device 110 during an RA procedure. Based on the first information, the first device 110 receives (240) the enhanced transmission of the message with the first transmission direction from the second device 120 during the RA procedure.

In some example embodiments, the RA procedure may be a 4-step RA procedure and the message with the first transmission direction may be at least one of: a message 2 (Msg 2) or a message 4 (Msg 4).

Alternatively, in some example embodiments, the RA procedure may be a 2-step RA procedure and the message with the first transmission direction may be a message B (Msg B).

In this way, the transmission of the message with the first transmission direction (i.e., from the second device 120 to the first device 110) may be enhanced.

In some example embodiments, the enhanced transmission of the message with the first transmission direction may be that the message with the first transmission direction is transmitted more than once. In this event, in some example embodiments, the first device 110 may receive each message with the first transmission direction separately until the message with the first transmission direction may be successfully decoded. Alternatively, in some example embodiments, the first device 110 may receive the message with the first transmission direction more than once and combine at least part of the received messages with the first transmission direction.

In the following, details about the first information are discussed. In some example embodiments, the first information may indicate an indication indicating that the message with the first transmission direction is to be transmitted more than once according to a pre-configured repetition factor, wherein the pre-configured repetition factor may be associated with a number of times of transmitting the message with the first transmission direction. In some example embodiments, the first information may indicate that the message with the first transmission direction is to be transmitted with a TB scaling factor lower than 0.25.

Alternatively, or in addition, in some example embodiments, the first information may indicate a repetition factor to be used for the enhanced transmission of the message with the first transmission direction.

Alternatively, or in addition, in some example embodiments, the first information may indicate a value of transport block (TB) scaling factor lower than 0.25 (for example, 0.125).

In some example embodiments, the first information may be downlink control information (DCI), and the first information may indicate the first configuration via at least part of transport block (TB) scaling bits as discussed below.

In some example embodiments, one of the most significant bit (MSB) and the least significant bit (LSB) may be used for indicating the first configuration, and the other one of the MSB and the LSB may be used for indicating a TB scaling factor (such as, ‘0’ indicates that the TB scaling factor is 0.5 while ‘0’ indicates that the TB scaling factor is 0.25).

In some example embodiments, all of the TB scaling bits may be used for indicating the first configuration, for example, the TB scaling bits may indicate a repetition factor.

In some example embodiments, all of the TB scaling bits may be used for indicating a codepoint to a table (such as, below table 2) of corresponding repetition factors.

TABLE 2

| Codepoint | repetition factor |
|---|---|
| 00 | 1 |
| 01 | 2 |
| 10 | 4 |
| 11 | 8 |

In some example embodiments, the above table of corresponding repetition factors may be defined as a default configuration, or may be configured by the second device 120.

In some example embodiments, codepoint, a part of the codepoints may be available for indicating the first configuration, or all of the codepoints may be available for indicating the first configuration.

Alternatively, in some example embodiments, a reserved codepoint of the TB scaling bits may be used for indicating the first configuration, and the other codepoints may be used for indicating TB scaling factors.

In some example embodiments, the number of the TB scaling bits may be two and the reserved codepoint may be [11].

In some example embodiments, in case that the TB scaling bits are set to be a reserved codepoint or all of the TB scaling bits are used for indicating the first configuration, a TB scaling factor may be determined to be one of the following:
a default value,
a first value configured by the second device 120, or
the value of the TB scaling factor indicated by the first configuration if the TB scaling bits may be set to be the reserved codepoint.

In some example embodiments, the default value may be one of the following: the maximum TB scaling factor (such as, 1), or the minimum TB scaling factor (such as. 0.25).

In some example embodiments, the first device 110 may transmit (220) a message with a second transmission direction from the first device 110 to the second device 120 during the RA procedure, where the message with the second transmission direction may indicate that the first device 110 supports the enhanced transmission of the message with the first transmission direction.

In some example embodiments, the message with the second transmission direction may be a PRACH transmission. In some example embodiments, the PRACH transmission may be associated with a specific preamble. Alternatively, in some example embodiments, the PRACH transmission may be associated with a specific random access channel occasion (RO). In particular, the specific preamble and the specific RO may imply that the first device 110 supports the enhanced transmission of the message with the first transmission direction.

In some example embodiments, the message with the second transmission direction may be a message 3 (Msg 3) during the RA procedure.

In some example embodiments, the transmission of the message with the second transmission direction may be performed conditionally.

As one example, the first device 110 may transmit the message with the second transmission direction to the second device 120 in accordance with a determination that a signal quality between the first device 110 and the second device 120 is below or equal to a threshold quality. In some example embodiments, threshold quality may be defined to be a default value or configured by the second device 120.

Alternatively, in another example, the first device 110 may transmit the message with the second transmission direction to the second device 120 in case of an absence of configuration of the enhanced transmission in system information.

In some example embodiments, the second device 120 may pre-configure at least one parameter about the enhanced transmission of a message with a first transmission direction. In some example embodiments, prior to transmitting the message with the second transmission direction, the first device 110 may receive (210) second information from the second device 120, where the second information may indicate a repetition factor to be used for the enhanced transmission of the message with the first transmission direction.

In some example embodiments, the second information may be included in system information (SI).

In order to a better understanding about the above example processes, some further details are discussed as below.

In some example embodiments, the Msg 2/Msg 4/Msg B enhancement may refer to the Msg 2/Msg 4/Msg B repetitions, and thus, “the Msg 2/Msg 4/Msg B enhancement” and “the Msg 2/Msg 4/Msg B repetitions” may be used interchangeably.

In some example embodiments, UE may provide a request for the Msg 2/Msg 4/Msg B PDSCH resources extension (e.g., repetitions), or may report a capability of the Msg 2/Msg 4/Msg B PDSCH resources extension (e.g., repetitions).

In some example embodiments, the request for or capability of the Msg 2/Msg 4/Msg B PDSCH resources extension (or the capability of Msg 2/Msg 4/Msg B enhancements) may be indicated via PRACH resources, e.g., via specific PRACH preamble or PRACH occasion (i.e., RO occasion).

In some example embodiments, the request for Msg4 enhancements or capability of Msg 4 enhancements (and this would only apply to Msg4) is indicated via Msg3. Specifically, when the capability or request is indicated via Msg 3, the indication of the Msg 4 PDSCH resources extension from gNB to UE is transmitted via the DCI format 1_0 with CRC scrambled by RA-RNTI (i.e., before Msg 3), but whether the UE would consider it or not for Msg 4 reception would depend on UE capability or request transmitted via Msg 3. gNB would eventually consider the indication via Msg 3 for scheduling of Msg 4.

In some example embodiments, the request for the Msg 2/Msg 4/Msg B PDSCH resources extension (or the capability of Msg 2/Msg 4/Msg B enhancements) may be associated to the UE repetition request or capability for a DCI 1_0 scheduling Msg 2/Msg 4/Msg B with repetitions. As one specific example embodiment, if UE requested DCI 1_0 with repetitions and repetition factor X, the request for the Msg 2/Msg 4/Msg B PDSCH resources extension (or the capability of Msg 2/Msg 4/Msg B enhancements) may be associated with X (such as, a function of X) based on pre-determined rules.

In some example embodiments, the request for the Msg 2/Msg 4/Msg B PDSCH resources extension (or the capability of Msg 2/Msg 4/Msg B enhancements) may be transmitted depending on the measured signal quality (such as, SS-RSRP). In one example embodiment, if the measured signal quality is lower than a threshold, the UE may send the request for the Msg 2/Msg 4/Msg B PDSCH resources extension (or the capability of Msg 2/Msg 4/Msg B enhancements) to the gNB.

Additionally, the threshold may be configured by the gNB, and further if the threshold has been not configured, a predefined value may be applied.

In the following, how does the gNB configure/indicate the enhanced transmission is discussed.

In summary, an indication related to Msg 2/Msg 4/Msg B PDSCH resource extension via the TB scaling bits in the DCI format 1_0 with CRC scrambled by RA-RNTI may be provided. In particular, the indication related to Msg 2/Msg 4/Msg B PDSCH resource extension may include either a repetition factor of Msg 2/Msg 4/Msg B PDSCH resources (e.g., repetition factor in case of PDSCH repetitions), or a trigger of a configured repetition factor of Msg 2/Msg 4/Msg B PDSCH resources (i.e., indication indicating that the message with the first transmission direction is to be transmitted more than once).

In some example embodiments, the gNB may transmit a repetition factor of Msg 2/Msg 4/Msg B PDSCH resources to the UE. Alternatively, or in addition, in some example embodiments, the gNB may transmit a trigger of a configured repetition factor of Msg 2/Msg 4/Msg B PDSCH resources via the TB scaling bits in DCI format 1_0 with CRC scrambled by RA-RNTI to the gNB.

In some example embodiments, all of the TB scaling bits (2 bits) may be used for indicating the enhanced transmission. As one example embodiment, all of the TB scaling bits may be used for explicitly indicating the repetition factor.

As another example embodiment, all of the TB scaling bits (2 bits) may be used for implicitly indicate the repetition factor, e.g., all of the TB scaling bits may indicate a codepoint to a row of a table of values of repetition factors. Additionally, in some example embodiments, the table of corresponding repetition factors may be defined as a default configuration. Alternatively, the table of corresponding repetition factors may be configured by gNB via higher layer signalling. Further, if the table is not configured by the gNB, the UE may utilize a default Table.

In some example embodiments, since all of the TB scaling bits are used for indicating the repetition factor, the UE may determine the TB scaling factor based on a pre-defined default value or based on a higher layer configuration of a TB scaling factor that applies only to enhanced UEs (i.e., UEs being able to receive the extended PDSCH).

In some example embodiments, all of the codepoints generated by the TB scaling bits (such as, [00], [01], [10], [11]) may be used for the indication related to Msg 2/Msg 4/Msg B PDSCH resource extension.

In one embodiment, part of the codepoints generated by the TB scaling bits (such as, [00], [01], [10], [11]) may be used for the indication related to Msg 2/Msg 4/Msg B PDSCH resource extension. For example, only the codepoints [00], [01], [10] may be used for the indication, which keeps backwards compatibility and allows the legacy (not enhanced) UEs to at least understand that a certain scaling factor is being indicated. In other words, the legacy UEs may interpret the TB scaling field normally, whereas the enhanced UEs may interpret the field as being used for the indication related to Msg 2/Msg 4/Msg B PDSCH resource extension.

In some example embodiments, part of the TB scaling bits may be used for the indication related to Msg 2/Msg 4/Msg B PDSCH resource extension and the remaining TB scaling bits may be used for indicating a subset of the TB scaling factors. In one example embodiment, the most significant bit (MSB) of the TB scaling bits may be used for the indication whereas the least significant bit (LSB) may be used for selecting one of two states of a subset of the TB scaling factors. In one example, the subset of TB scaling factors may include a first value (such as, 0.5) and a second value (such as, 0.25), and the LSB may be used for the selection between the first and second values.

In some example embodiments, the reserved codepoint (such as, [11]) of the TB scaling bits may be used for the indication related to Msg 2/Msg 4/Msg B PDSCH resource extension. In one embodiment, the reserved codepoint (such as, [11]) may be used for indicating a trigger of a configured or specified repetition factor of Msg 2/Msg 4/Msg B PDSCH resources, while the other states may be used for legacy indication of TB scaling factor.

Additionally, in some example embodiments, if the reserved codepoint (such as, [11]) is used for the indication related to Msg 2/Msg 4/Msg B PDSCH resource extension, the UE may assume a fixed TB scaling factor value. For example, UE may assume the TB scaling factor to be equal to the minimum TB scaling factor (i.e., 0.25). In another example, UE may assume the TB scaling factor to be equal to the maximum TB scaling factor (i.e., 1). In yet another example, the UE may assume the TB scaling factor to be equal to a configured or specified TB scaling factor (i.e., 0.5).

In some example embodiments, the reserved codepoint (such as, [11]) of the TB scaling bits may be used for indicating a lower TB scaling factor than what currently supported. For example, the reserved codepoint may be used for indicating a TB scaling of a half of the current minimum (i.e., 0.125).

In some example embodiments, the reception of extended Msg 2/Msg 4/Msg B PDSCH at the UE may be performed based on the indication related to Msg 2/Msg 4/Msg B PDSCH resource extension.

In some example embodiments, in case that the extended Msg 2/Msg 4/Msg B PDSCH is Msg 2/Msg 4/Msg B repetition, the UE may receive each Msg 2/Msg 4/Msg B PDSCH repetition separately until the Msg 2/Msg 4/Msg B PDSCH is successfully decoded. Alternatively, in some embodiments, in case that the extended Msg 2/Msg 4/Msg B PDSCH is Msg 2/Msg 4/Msg B repetition, the UE may combine all the Msg 2/Msg 4/Msg B PDSCH transmissions before decoding the Msg 2/Msg 4/Msg B payload.

Reference is now made to FIG. 3, which illustrates a signaling flow 300 of communication in accordance with some embodiments of the present disclosure. In FIG. 3, the UE and the gNB may be implemented as the first device 110 and the second device 120 in FIG. 1, respectively. The below specific example embodiment should not be interpreted as any limitations to the present disclosure.

In FIG. 3, a repetition factor of Msg 2 PDSCH resources is configured and dynamically triggered via the reserved codepoint (such as, [11]) of the TB scaling factor field in the DCI. In this example embodiment, and without loss of generality, the repetition factor may refer to as repetition factor for a set of N PDSCH repetitions.

As illustrated in FIG. 3, the UE may receive (310) a configuration of Msg 2 repetition factor from the gNB, and the gNB may transmit (315) the configuration of Msg 2 repetition factor to the UE accordingly. In this way, the UE may be configured from gNB via SIB1 with a repetition factor (N repetitions in this example) for the Msg 2 PDSCH.

In some example embodiments, the configuration of Msg 2 repetition factor may be in PDSCH-TimeDomainResourceAllocationList in PDSCH-ConfigCommon.

The UE may transmit (320) the Msg2 repetition capability indication via PRACH resources to the gNB, and the gNB may receive (325) the Msg 2 repetition capability indication via PRACH resources from the UE accordingly. In this way, the UE may indicate capability of Msg 2 repetitions via specific choice of PRACH resources. As one example embodiment, the UE may transmit a PRACH transmission in specific PRACH occasions (i.e., ROs) to indicate its capability. Alternatively, the UE may transmit a PRACH transmission with a specific preamble to indicate its capability. Alternatively, the UE may transmit a PRACH transmission with a specific preamble in specific ROs to indicate its capability.

Next, the UE may receive (330) a DCI 1_0 message with CRC scrambled by the RA-RNTI (corresponding to the RO used by the UE for indicating capability), and the gNB may transmit (335) the DCI 1_0 message to the UE accordingly. Further, the DCI message may be used for scheduling the Msg2 PDSCH and the TB scaling field in the DCI is set to [11].

In the following, the UE successfully may decode (340) the DCI 1_0 and understands that the configured repetition factor is enabled for the subsequent Msg2 PDSCH.

In some example embodiments, UE may use the indication (i.e., the TB scaling field) to understand that the PDSCH is with N repetitions and to set (350) the TB scaling factor of the single PDSCH to 0.25.

After that, the UE may receive (360-1, 360-2, . . . , 360-N)/the gNB may transmit (365-1, 365-2, . . . , 365-N) the N Msg2 PDSCH repetitions, and thus a more reliable decoding of the Msg2 payload may be achieved.

According to the above example processes, the downlink transmission during the RA procedure may be achieved.

### Example Methods

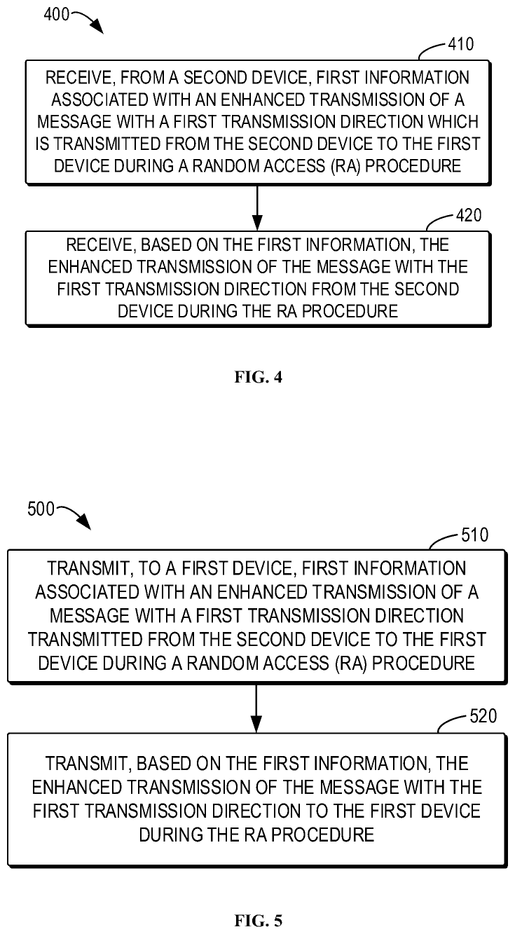

FIG. 4 shows a flowchart of an example method 400 implemented at a first device in accordance with some example embodiments of the present disclosure. For the purpose of discussion, the method 400 would be described from the perspective of the first device 110 in FIG. 1A and further by referring to FIG. 2.

At block 410, the first device 110 may receive (230), from a second device 120, first information associated with an enhanced transmission of a message with a first transmission direction which is transmitted from the second device 120 to the first device 110 during a random access (RA) procedure.

At block 420, the first device 110 may receive (240), based on the first information, the enhanced transmission of the message with the first transmission direction from the second device 120 during the RA procedure.

In some example embodiments, the enhanced transmission of the message with the first transmission direction may be that the message with the first transmission direction is transmitted more than once. The first device 110 may receive, from the second device 120, each message with the first transmission direction separately until the message with the first transmission direction is successfully decoded, or may receive, from the second device, the message with the first transmission direction more than once and combine at least part of the received messages with the first transmission direction.

In some example embodiments, the first information may indicate a first configuration including at least one of the following: an indication indicating that the message with the first transmission direction is to be transmitted more than once according to a pre-configured repetition factor, wherein the pre-configured repetition factor is associated with a number of times of transmitting the message with the first transmission direction, a repetition factor to be used for the enhanced transmission of the message with the first transmission direction, or a value of transport block (TB) scaling factor lower than the minimum TB scaling factor.

In some example embodiments, the first information may be downlink control information (DCI), and the first information may indicate the first configuration via at least part of transport block (TB) scaling bits.

In some example embodiments, one of the most significant bit (MSB) and the least significant bit (LSB) may be used for indicating the first configuration, and the other one of the MSB and the LSB may be used for indicating a TB scaling factor.

In some example embodiments, all of the TB scaling bits may be used for indicating the first configuration, and the TB scaling bits may indicate at least one of the following: a repetition factor, or a codepoint to a table of corresponding repetition factors.

In some example embodiments, the table of corresponding repetition factors may be defined as a default configuration, or may be configured by the second device.

In some example embodiments, the TB scaling bits may correspond to a plurality of codepoints, and wherein, a part of the plurality of codepoints may be available for indicating the first configuration, or all of the plurality of codepoints may be available for indicating the first configuration.

In some example embodiments, the TB scaling bits may correspond to a plurality of codepoints, and wherein, a reserved codepoint of the plurality of codepoints may be used for indicating the first configuration, and the other codepoints of the plurality of codepoints may be used for indicating candidate TB scaling factors.

In some example embodiments, the number of the TB scaling bits may be two and the reserved codepoint may be [11].

In some example embodiments, in case that the TB scaling bits are set to be a reserved codepoint or all of the TB scaling bits are used for indicating the first configuration, a TB scaling factor may be determined to be one of the following: a default value, a first value configured by the second device, or the value of the TB scaling factor indicated by the first configuration if the TB scaling bits are set to be the reserved codepoint.

In some example embodiments, the default value may be one of the following: the maximum TB scaling factor, or the minimum TB scaling factor.

In some example embodiments, the first device 110 may transmit (220) a message with a second transmission direction from the first device 110 to the second device 120 during the RA procedure, the message with the second transmission direction indicating that the first device 110 supports the enhanced transmission of the message with the first transmission direction.

In some example embodiments, the message with the second transmission direction may be a physical random access channel (PRACH) transmission and may be associated with at least one of the following: a specific preamble, or a specific random access channel occasion (RO), wherein the specific preamble and the specific RO may imply that the first device 110 supports the enhanced transmission of the message with the first transmission direction.

In some example embodiments, the message with the second transmission direction may be a message 3 (Msg 3) during the RA procedure, and the message with the first transmission direction may be a message 4 (Msg 4) during the RA procedure.

In some example embodiments, the first device 110 may transmit the message with the second transmission direction to the second device 120 in accordance with a determination that a signal quality between the first device 110 and the second device 120 is below or equal to a threshold quality, or may transmit the message with the second transmission direction to the second device 120 in case of an absence of configuration of the enhanced transmission in system information.

In some example embodiments, the threshold quality may be defined to be a default value or configured by the second device.

In some example embodiments, prior to transmitting the message with the second transmission direction, the first device may receive (210) second information from the second device, the second information indicating a repetition factor to be used for the enhanced transmission of the message with the first transmission direction.

In some example embodiments, the second information may be included in system information (SI).

In some example embodiments, the RA procedure may be a 4-step RA procedure and the message with the first transmission direction may be at least one of: a message 2 (Msg 2) or a message 4 (Msg 4), or the RA procedure may be a 2-step RA procedure and the message with the first transmission direction may be a message B (Msg B).

In some example embodiments, the first device 110 may be a terminal device and the second device 120 may be a network device.

FIG. 5 shows a flowchart of an example method 500 implemented at a second device 120 in accordance with some example embodiments of the present disclosure. For the purpose of discussion, the method 500 may be described from the perspective of the second device 120 in FIG. 1A and further by referring to FIG. 2.

At block 510, the second device 120 may transmit (235), to a first device 110, first information associated with an enhanced transmission of a message with a first transmission direction transmitted from the second device 120 to the first device 110 during a random access (RA) procedure.

At block 520, the second device 120 may transmit (245), based on the first information, the enhanced transmission of the message with the first transmission direction to the first device 110 during the RA procedure.

In some example embodiments, the enhanced transmission of the message with the first transmission direction may be that the message with the first transmission direction may be transmitted more than once.

In some example embodiments, the first information may indicate a first configuration comprising at least one of the following: an indication indicating that the message with the first transmission direction is to be transmitted more than once according to a pre-configured repetition factor, wherein the pre-configured repetition factor is associated with a number of times of transmitting the message with the first transmission direction, a repetition factor to be used for the enhanced transmission of the message with the first transmission direction, or a value of transport block (TB) scaling factor lower than the minimum TB scaling factor.

In some example embodiments, the first information may be downlink control information (DCI), and the first information may indicate the first configuration via at least part of transport block (TB) scaling bits.

In some example embodiments, one of the most significant bit (MSB) and the least significant bit (LSB) may be used for indicating the first configuration, and the other one of the MSB and the LSB may be used for indicating a TB scaling factor.

In some example embodiments, all of the TB scaling bits may be used for indicating the first configuration, and the TB scaling bits may indicate at least one of the following: a repetition factor, or a codepoint to a table of corresponding repetition factors.

In some example embodiments, the table of corresponding repetition factors may be defined as a default configuration, or may be configured by the second device.

In some example embodiments, the TB scaling bits may correspond to a plurality of codepoints, and wherein, a part of the plurality of codepoints may be available for indicating the first configuration, or all of the plurality of codepoints may be available for indicating the first configuration.

In some example embodiments, the TB scaling bits may correspond to a plurality of codepoints, and wherein, a reserved codepoint of the plurality of codepoints may be used for indicating the first configuration, and the other codepoints of the plurality of codepoints may be used for indicating candidate TB scaling factors.

In some example embodiments, the number of the TB scaling bits may be two and the reserved codepoint may be [11].

In some example embodiments, in case that the TB scaling bits are set to be a reserved codepoint or all of the TB scaling bits are used for indicating the first configuration, and a TB scaling factor may be determined to be one of the following: a default value, a first value configured by the second device, or the value of the TB scaling factor indicated by the first configuration if the TB scaling bits are set to be the reserved codepoint.

In some example embodiments, the default value may be one of the following: the maximum TB scaling factor, or the minimum TB scaling factor.

In some example embodiments, the second device 120 may receive (225) a message with a second transmission direction from the first device 110 during the RA procedure, the message with the second transmission direction indicating that the first device 110 supports the enhanced transmission of the message with a first transmission direction.

In some example embodiments, the message with the second transmission direction may be a physical random access channel (PRACH) transmission and may be associated with at least one of the following: a specific preamble, or a specific random access channel occasion (RO), wherein the specific preamble and the specific RO may imply that the first device 110 supports the enhanced transmission of the message with the first transmission direction.

In some example embodiments, the message with the second transmission direction may be a message 3 (Msg 3) during the RA procedure, and the message with the first transmission direction may be a message 4 (Msg 4) during the RA procedure.

In some example embodiments, prior to receiving the message with the second transmission direction, the second device 120 may transmit (215) second information to the first device 110, the second information indicating a repetition factor to be used for the enhanced transmission of the message with the first transmission direction.

In some example embodiments, the second information may be included in system information (SI).

In some example embodiments, the RA procedure may be a 4-step RA procedure and the message with the first transmission direction may be at least one of: a message 2 (Msg 2) or a message 4 (Msg 4), or the RA procedure may be a 2-step RA procedure and the message with the first transmission direction may be a message B (Msg B).

In some example embodiments, the first device 110 may be a terminal device and the second device 120 may be a network device.

### Example Apparatus, Device and Medium

In some example embodiments, a first apparatus capable of performing any of the method 400 (for example, the first device 110 in FIG. 1A may include means for performing the respective operations of the method 400. The means may be implemented in any suitable form. For example, the means may be implemented in a circuitry or software module. The first apparatus may be implemented as or included in the first device 110 in FIG. 1A.

In some example embodiments, the first apparatus includes means for receiving, from a second device, first information associated with an enhanced transmission of a message with a first transmission direction which is transmitted from the second device to the first device during a random access (RA) procedure; and means for receiving, based on the first information, the enhanced transmission of the message with the first transmission direction from the second device during the RA procedure.

In some example embodiments, the first apparatus further includes means for performing other operations in some example embodiments of the method 400 or the first device 110. In some example embodiments, the means includes at least one processor;

and at least one memory storing instructions that, when executed by the at least one processor, cause the performance of the first apparatus.

In some example embodiments, a second apparatus capable of performing any of the method 500 (for example, the second device 120 in FIG. 1A may include means for performing the respective operations of the method 500. The means may be implemented in any suitable form. For example, the means may be implemented in a circuitry or software module. The second apparatus may be implemented as or included in the second device 120 in FIG. 1A.

In some example embodiments, the second apparatus includes means for transmitting, to a first device, first information associated with an enhanced transmission of a message with a first transmission direction transmitted from the second device to the first device during a random access (RA) procedure; and means for transmitting, based on the first information, the enhanced transmission of the message with the first transmission direction to the first device during the RA procedure.

In some example embodiments, the second apparatus further includes means for performing other operations in some example embodiments of the method 500 or the second device 120. In some example embodiments, the means includes at least one processor; and at least one memory storing instructions that, when executed by the at least one processor, cause the performance of the second apparatus.

In some example embodiments, there is provided a computer readable medium. The computer readable medium includes instructions stored thereon for causing an apparatus at least to: receive, from a second device, first information associated with an enhanced transmission of a message with a first transmission direction which is transmitted from the second device to the first device during a random access (RA) procedure; and receive, based on the first information, the enhanced transmission of the message with the first transmission direction from the second device during the RA procedure.

In some example embodiments, there is provided a computer readable medium. The computer readable medium includes instructions stored thereon for causing an apparatus at least to: transmit, to a first device, first information associated with an enhanced transmission of a message with a first transmission direction transmitted from the second device to the first device during a random access (RA) procedure; and transmit, based on the first information, the enhanced transmission of the message with the first transmission direction to the first device during the RA procedure.

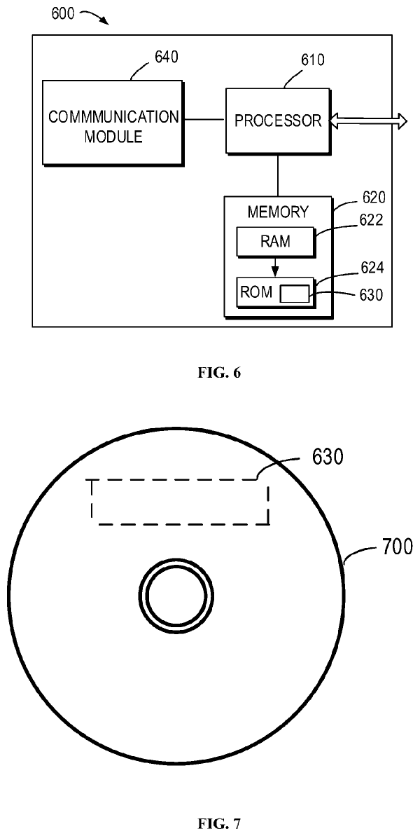

FIG. 6 is a simplified block diagram of a device 600 that is suitable for implementing example embodiments of the present disclosure. The device 600 may be provided to implement a communication device, for example, the first device 110 or the second device 120 as shown in FIG. 1A. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that may not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. BBBB shows an example of the computer readable medium BBBB00 which may be in form of CD, DVD or other optical storage disk. The computer readable medium BBBB00 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-83. (canceled)

84. A first device comprising:
at least one processor; and
at least one memory storing instructions that, when executed by the at least one processor, cause the first device at least to:
receive, from a second device, first information associated with an enhanced transmission of a message with a first transmission direction which is transmitted from the second device to the first device during a random access (RA) procedure; and
receive, based on the first information, the enhanced transmission of the message with the first transmission direction from the second device during the RA procedure.

85. The first device of claim 84, wherein the enhanced transmission of the message with the first transmission direction is that the message with the first transmission direction is transmitted more than once,
and wherein the first device is further caused to:
receive, from the second device, each message with the first transmission direction separately until the message with the first transmission direction is successfully decoded, or
receive, from the second device, the message with the first transmission direction more than once and combine at least part of the received messages with the first transmission direction.

86. The first device of claim 84, wherein the first information indicates a first configuration comprising at least one of the following:
an indication indicating that the message with the first transmission direction is to be transmitted more than once according to a pre-configured repetition factor, wherein the pre-configured repetition factor is associated with a number of times of transmitting the message with the first transmission direction,
a repetition factor to be used for the enhanced transmission of the message with the first transmission direction, or
a value of transport block (TB) scaling factor lower than a minimum TB scaling factor.

87. The first device of claim 86, wherein the first information is downlink control information (DCI), and the first information indicates the first configuration via at least part of transport block (TB) scaling bits.

88. The first device of claim 87, wherein,
one of the most significant bit (MSB) and the least significant bit (LSB) is used for indicating the first configuration, and
the other one of the MSB and the LSB is used for indicating a TB scaling factor.

89. The first device of claim 87, wherein all of the TB scaling bits are used for indicating the first configuration, and the TB scaling bits indicate at least one of the following:
a repetition factor, or
a codepoint to a table of corresponding repetition factors.

90. The first device of claim 89, wherein the table of corresponding repetition factors is defined as a default configuration, or is configured by the second device.

91. The first device of claim 87, wherein the TB scaling bits correspond to a plurality of codepoints, and wherein,
a part of the plurality of codepoints are available for indicating the first configuration, or
all of the plurality of codepoints are available for indicating the first configuration.

92. The first device of claim 87, wherein the TB scaling bits correspond to a plurality of codepoints, and wherein,
a reserved codepoint of the plurality of codepoints is used for indicating the first configuration, and
the other codepoints of the plurality of codepoints are used for indicating candidate TB scaling factors.

93. The first device of claim 92, wherein the number of the TB scaling bits is two and the reserved codepoint is [11].

94. The first device of claim 87, wherein in case that the TB scaling bits are set to be a reserved codepoint or all of the TB scaling bits are used for indicating the first configuration, a TB scaling factor is determined to be one of the following:
a default value,
a first value configured by the second device, or
the value of the TB scaling factor indicated by the first configuration if the TB scaling bits are set to be the reserved codepoint.

95. The first device of claim 94, wherein the default value is one of the following:
the maximum TB scaling factor, or
the minimum TB scaling factor.

96. The first device of claim 84, wherein the first device is further caused to:
transmit a message with a second transmission direction from the first device to the second device during the RA procedure, the message with the second transmission direction indicating that the first device supports the enhanced transmission of the message with the first transmission direction.

97. The first device of claim 96, wherein the message with the second transmission direction is a physical random access channel (PRACH) transmission and is associated with at least one of the following:
a specific preamble, or
a specific random access channel occasion (RO),
wherein the specific preamble and the specific RO imply that the first device supports the enhanced transmission of the message with the first transmission direction.

98. The first device of claim 96, wherein the message with the second transmission direction is a message 3 (Msg 3) during the RA procedure, and the message with the first transmission direction is a message 4 (Msg 4) during the RA procedure.

99. The first device of claim 96, wherein the first device is further caused to:
transmit the message with the second transmission direction to the second device in accordance with a determination that a signal quality between the first device and the second device is below or equal to a threshold quality, or
transmit the message with the second transmission direction to the second device in case of an absence of configuration of the enhanced transmission in system information.

100. The first device of claim 99, wherein the threshold quality is defined to be a default value or configured by the second device.

101. The first device of claim 96, wherein the first device is further caused to:
prior to transmitting the message with the second transmission direction, receive second information from the second device, the second information indicating a repetition factor to be used for the enhanced transmission of the message with the first transmission direction.

102. The first device of claim 101, wherein the second information is comprised in system information (SI).

103. The first device of claim 84, wherein,
the RA procedure is a 4-step RA procedure and the message with the first transmission direction is at least one of: a message 2 (Msg 2) or a message 4 (Msg 4), or
the RA procedure is a 2-step RA procedure and the message with the first transmission direction is a message B (Msg B).

104. The first device of claim 84, wherein the first device is a terminal device and the second device is a network device.

105. A second device comprising:
at least one processor; and
at least one memory storing instructions that, when executed by the at least one processor, cause the second device at least to:
transmit, to a first device, first information associated with an enhanced transmission of a message with a first transmission direction transmitted from the second device to the first device during a random access (RA) procedure; and
transmit, based on the first information, the enhanced transmission of the message with the first transmission direction to the first device during the RA procedure.
